(19) United States
(12) Patent Application Publication
(10) Pub. No.: US 2024/0185059 A1
(43) Pub. Date: Jun. 6, 2024

(54) METHOD FOR TWO-WAY TIME SERIES DIMENSION REDUCTION

(71) Applicant: Hitachi, Ltd., Tokyo (JP)

(72) Inventors: Aniruddha Rajendra RAO, San Jose, CA (US); Haiyan WANG, Fremont, CA (US); Chetan GUPTA, San Mateo, CA (US)

(21) Appl. No.: 18/075,228

(22) Filed: Dec. 5, 2022

(51) Int. Cl. G06N 3/08; G06N 3/0455

(52) U.S. Cl. CPC G06N 3/08; G06N 3/0455

(57) ABSTRACT

Systems and methods described herein can involve training a functional encoder involving a plurality of layers of continuous neurons from input time series data to learn a dimension reduced form of the input time series data, the dimension reduced form of the input time series data being at least one of a feature reduced or time point reduced form of the input time series data; and training a functional decoder comprising another plurality of layers of continuous neurons to learn the input time series data from the dimension reduced form of the input time series data.

### BACKGROUND

### Field

The present disclosure is generally directed to machine learning, and more specifically, to systems and methods for facilitating a two-way time series dimension reduction.

### Related Art

Time series analysis can be critical for many organizations in a wide variety of industrial sectors. The exponentially growing volume of time series data poses challenges for storage, transfer, and analysis. There have been various techniques developed in the area of dimension reduction. In the related art, there has not been a product or service that combines and performs dimension reduction for time series by reducing the number of features as well as the timepoints. Such a dimension reduction approach can be very useful, especially in the case of high-frequency data like vibration information from sensors, voice signals, and weather information.

In the related art, the solutions for dimension reduction are developed for multivariate problems, which give inadequate and linear representation, and cannot reduce the number of timepoints. For example, using PCA (Principal Component Analysis) and AE (Autoencoder may not capture the temporal information in the time series data.

Functional data analysis (FDA) has proven to be a great statistical approach to analyzing time-series data with patterns. Function-on-function models can be used to build mathematical mapping for time series data for dimension reduction. Compared to Deep Learning (DL), functional data modeling techniques use function-on-function models to be more efficient in terms of capturing the rich information in time-series data (i.e., needing fewer parameters), less restrictive on data format (i.e., data can have different resolutions across samples), and less restrictive on the underlying mapping (i.e., the parameters can be different at different times within the considered time horizons). However, methods like FPCA and FAE have drawbacks. FPCA (Functional Principal Component Analysis) only gives a linear representation but cannot capture complex relations, whereas FAE (Functional Autoencoder) is only able to give a scalar representation of the data, which is very limiting. Real data can be complex. Dimension reduction based on these related art methods will generate inaccurate results.

### SUMMARY

With the rapid progress in technology, data is being recorded at a huge rate. This increase in information is because of advancements in technology. The growth of information has been exponential especially for time series data, and there is a need for systems and methods that can help store such vast information with minimum loss of signal. In many cases, this information is not independent and exhibits complex relations making it a challenging problem to solve. Dimension reduction plays a key role in solving this problem by reducing the information in a meaningful manner. The objective of dimension reduction is to mathematically reduce the dimensionality by projecting the data to a lower dimensional subspace with minimum loss of information. The learned mathematical mapping plays an effective role in not only sorting out which variables are important, but also how they interact with each other.

Dimension reduction also helps to deal with the problem of dimensionality, ease the transfer of information, reduce storage requirements, and reduce computation time. The usefulness of dimension reduction makes it an active area of research. In the last few years, dimension reduction models have proven beneficial in many fields, like time series, text, image, and video. This has attracted the interest of researchers from the science community, especially where non-scalar types of data have become prevalent.

Example implementations described herein involve an innovative data-driven method that effectively learns the mathematical mapping of the time series to some low dimensional latent space without loss of information in many use cases like voice signals or vibration information that are measured at very high frequency and temperature readings which is recorded at very granular resolution. Accurate compact information is very important in this scenario to perform the different downstream tasks.

Compared to the related art, the proposed two-way dimension reduction approach in the example implementations described herein can involve the following advantages. The proposed system automatically captures non-linear relations existing in the data. The proposed system can reduce the number of features as well as the time points at which the time series is observed. Further, the superiority of the proposed system has been demonstrated by real-world data analysis.

The proposed forecasting approach can be valuable in the following scenarios, including a wide range of industries where information is stored at high frequency, and for systems in which the cost of data storage and transfer is an issue, among other scenarios. Further, using accurate dimension-reduced data makes it possible to execute analysis faster and more accurately through the use of the example implementations described herein.

Example implementations described herein can also be useful for any situation where dimension reduction for time series or functions is needed. Examples of these situations can involve vibration data in multiple industrial areas, transfer/storage of large audio information and weather data, and so on.

Example implementations described herein involve a novel approach referred herein as a Bi-Functional Autoencoder (BFAE) for time series dimension reduction using functional encoders and functional decoders, that allows the reduction in the number of features as well as timepoints (two way). The functional encoder uses the continuous neurons in the continuous hidden layer to get a low dimension latent representation of the data and this data can then propagate through the functional decoder to reconstruct the original information.

Aspects of the present disclosure can involve a method, which can include training a functional encoder comprising a plurality of layers of continuous neurons from input time series data to learn a dimension reduced form of the input time series data, the dimension reduced form of the input time series data being at least one of a feature reduced or time point reduced form of the input time series data; and training a functional decoder comprising another plurality of layers of continuous neurons to learn the input time series data from the dimension reduced form of the input time series data.

Aspects of the present disclosure can involve a computer program, storing instructions for executing a process, the instructions involving training a functional encoder comprising a plurality of layers of continuous neurons from input time series data to learn a dimension reduced form of the input time series data, the dimension reduced form of the input time series data being at least one of a feature reduced or time point reduced form of the input time series data; and training a functional decoder comprising another plurality of layers of continuous neurons to learn the input time series data from the dimension reduced form of the input time series data. The computer program and instructions can be stored on a non-transitory computer readable medium and executed by one or more processors.

Aspects of the present disclosure can involve an apparatus, which can include a processor configured to train a functional encoder comprising a plurality of layers of continuous neurons from input time series data to learn a dimension reduced form of the input time series data, the dimension reduced form of the input time series data being at least one of a feature reduced or time point reduced form of the input time series data; and train a functional decoder comprising another plurality of layers of continuous neurons to learn the input time series data from the dimension reduced form of the input time series data.

Aspects of the present disclosure can involve a system, which can include means for training a functional encoder comprising a plurality of layers of continuous neurons from input time series data to learn a dimension reduced form of the input time series data, the dimension reduced form of the input time series data being at least one of a feature reduced or time point reduced form of the input time series data; and means for training a functional decoder comprising another plurality of layers of continuous neurons to learn the input time series data from the dimension reduced form of the input time series data.

### BRIEF DESCRIPTION OF DRAWINGS

FIG. 1 is a flow diagram for the Dimension Reduction approach, in accordance with an example implementation.

FIG. 2 is a general architecture of Bi-Functional Auto-encoder (BFAE), in accordance with an example implementation.

FIGS. 3A and 3B illustrate a flow diagram for the application of the Dimension Reduction approach, in accordance with an example implementation.

FIGS. 3C to 3E illustrate example implementations as applied to data sets.

FIG. 3F illustrates an example comparison of other related art techniques and the proposed BFAE, in accordance with an example implementation.

FIG. 3G illustrates example results of a model trained from the proposed BFAE technique, in accordance with an example implementation.

FIG. 4 illustrates a system involving a plurality of physical systems networked to a management apparatus, in accordance with an example implementation.

FIG. 5 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art of practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve a novel approach called a Bi-Functional Autoencoder (BFAE) for time series dimension reduction using functional encoders and functional decoders. The proposed system has the following components.

Data collection and data storage units: This component collects historical data.

Data-driven encoder units: This component utilizes the proposed functional encoder in the BFAE approach to get a low-dimensional representation of the data.

Data-driven decoder model building units: This component utilizes the proposed functional decoder in the BFAE approach to reconstruct the original data using the low-dimensional representation of the data.

Model deploying units: This component deploys the learned model on streaming data to produce and transmit real-time data-driven information.

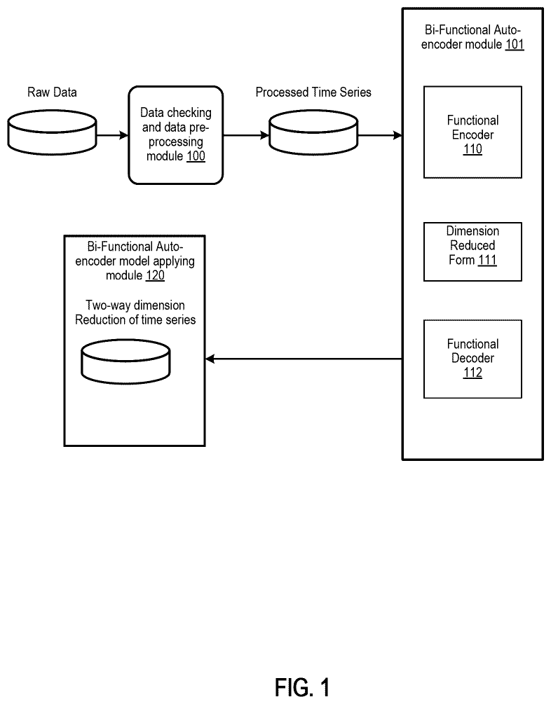

FIG. 1 illustrates an example flow diagram for the invented dimension reduction approach, in accordance with an example implementation. In the example implementations described herein, the approach as seen in FIG. 1 can be used for dimension reduction of the time series data.

The proposed data-driven approach involves the following modules.

Data checking and data pre-processing module 100: This module aims to ensure that the time series data to be used in the later calculation is regularly observed over time (i.e., without big time gaps between adjacent observations). The example implementations described herein also check for outliers and remove them if any.

BFAE module 101: This module conducts the learning phase of the BFAE for the dimension reduction with the help of a functional encoder 110 that gets the compact latent representation of the time series information and a functional decoder 112 that gets the original time series information back from the latent representation learned. The functional encoder 110 and the functional decoder 112 are used to learn the dimension reduced form 111 as described herein.

BFAE model applying module 120: This module conducts the applying phase of the learned dimension reduced data and utilizes the two-way reduction of time series data to learn models or retrieve the original data.

With regards to the data checking and data pre-processing module 100, there are a few steps involved in this module that are necessary to perform before the data is used as an input to these Machine Learning (ML) and Deep Learning (DL) algorithms. These relevant data preparation steps are performed on the input data before it is pushed into these algorithms. The example implementations described herein are not restricted to any specific data preparation method.

Examples of data checking and data pre-processing steps involve noise/outlier removal, and missing data imputation. Once data is prepared, it is further divided into training and testing sets. The training set is used during the model training phase, while the testing set is used for evaluating the model.

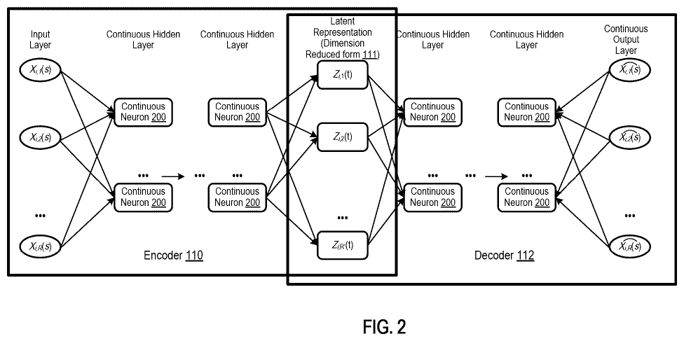

With regards to the BFAE module 101, provided herein are some mathematical notations for explanation. Suppose that the number of samples is N. For each of the samples, the time series data is observed within time range T. Let the observed data be defined using X^{(i,r)}(s_{i,j}), with s∈S (compact internal) for j=1, . . . , M, i=1, . . . , N, r=1, . . . , R. Example implementations described herein feed the time series into the proposed approach as shown in FIG. 2. FIG. 2 illustrates the general architecture of the BFAE, in accordance with an example implementation.

BFAE identifies the underlying patterns in the data to make the compact latent representation. It takes advantage of the Neural Network architecture as seen FIG. 2 to find the complex relations in these patterns. A Bi-Functional Auto-encoder (BFAE) can involve continuous neurons 200 which make up the continuous hidden layers. As illustrated in FIG. 2, each of the continuous neurons 200 is configured to receive a function as an input (e.g., from input layer or from a continuous neuron from a previous continuous hidden layer) and executes a non-linear transformation to generate an output function that can be provided as output to the next continuous hidden layer or eventually into the dimension reduced form 111.

The l^{th} continuous hidden layer and r^{th} continuous neuron is defined as follows, H₍ₗ₎^{(i,r)}(s)=σ(b₍ₗ₎^{(r)}(s)+Σⱼ₌₁^{J}∫w₍ₗ₎^{(r,j)}(s,t)H₍ₗ₋₁₎^{(r,j)}(t)dt) where σ is the activation function, b₍ₗ₎^{(r)}(s) is the parameter function and w₍ₗ₎^{(r,j)}(s,t) is the bivariate parameter function. Using the defined continuous neurons 200 as described above, example implementations described herein can complete the forward propagation and compute the partial derivatives to update the parameter functions in the back-propagation step. Accordingly, the functional encoder 110 executes a non-linear transformation to generate an output function that is used to feed into a subsequent continuous neuron through forward propagation. The example implementations go back and forth between the forward and backward propagation until a stopping criterion is reached (e.g., as set in accordance with the desired implementation). BFAE performs dimension reduction with the help of a functional encoder 110, which takes the information from the input layer and passes through multiple continuous hidden layers until the example implementations get to the layer that gives the compact latent representation of the time series information, denoted by Z_{(l′)}^{(R′)}(t), and the functional decoder 112 that gets the original time series information back from the latent representation learned. The dimension reduced form 111 of the input time series data is a non-linear dimension reduced form as indicated.

Further, example implementations described herein provide the freedom to set the number of features and the number of timepoints at which the features are observed in the latent representation layer. Thus, the user of such as system can define the desired feature reduction (e.g., define the number of features to be reduced, define which features to omit, etc.) and/or time point reduction (e.g., reducing the number of time point samples used) for the dimension reduced form 111 of the input times series data, which is then generated by the functional encoder 110.

Further, example implementations described herein can allow users to define the number of layers of continuous neurons or the number of continuous neurons in accordance with the desired implementation. The functional encoder 110 can then be constructed according to the desired definition as input.

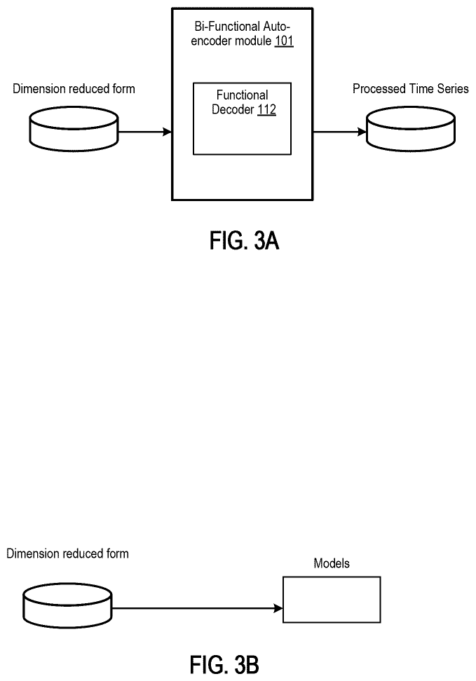

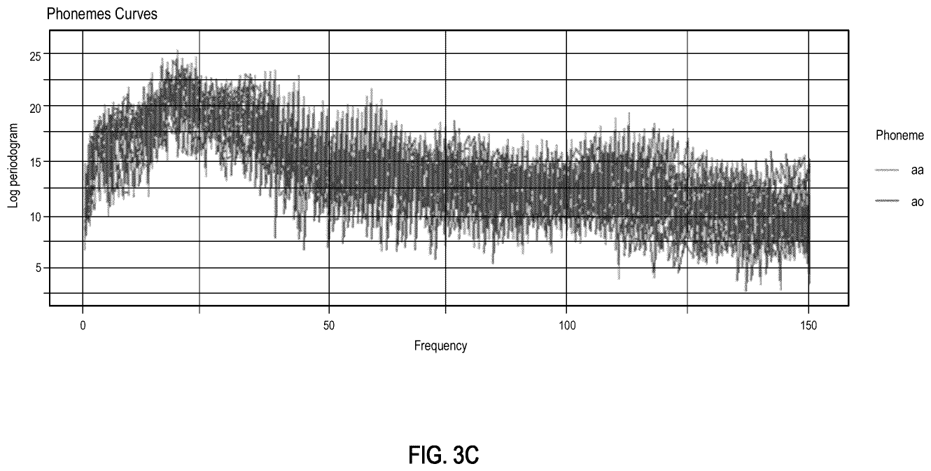

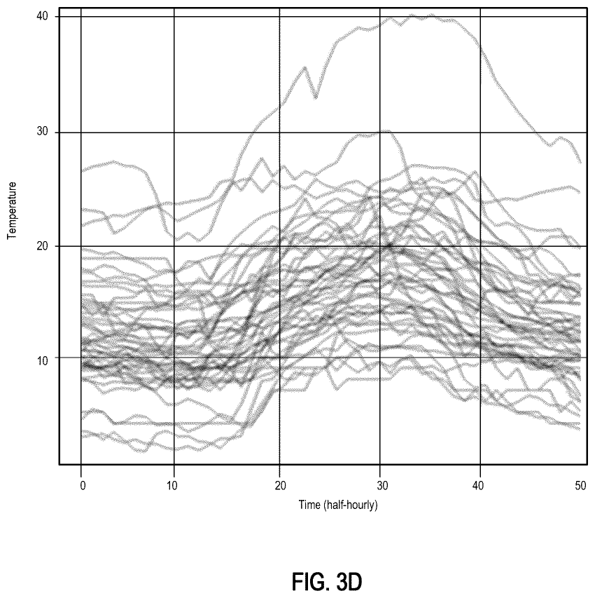

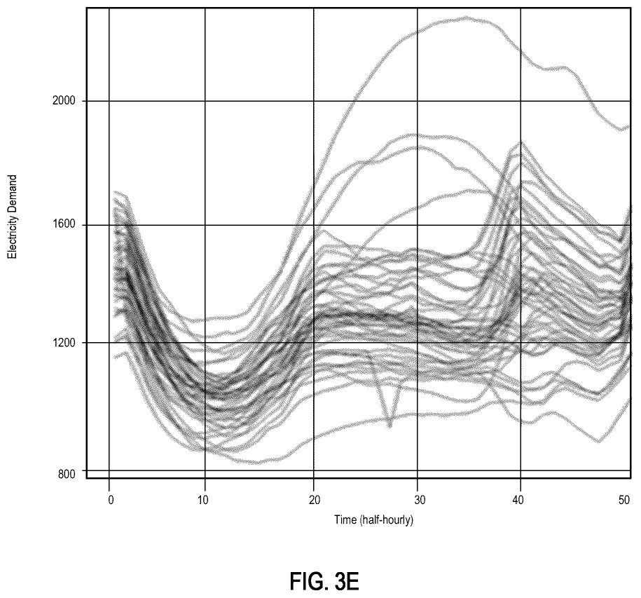

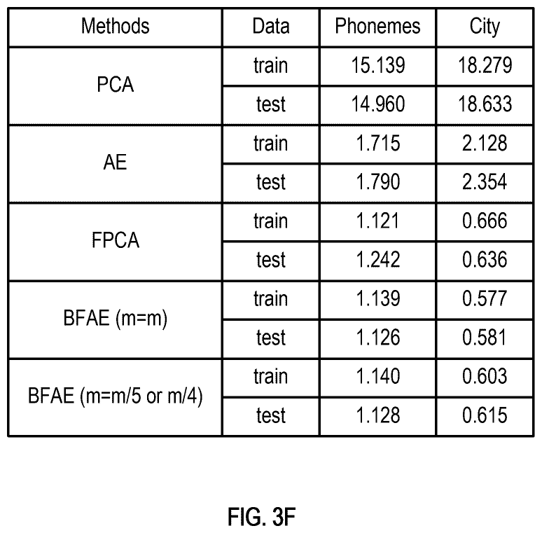

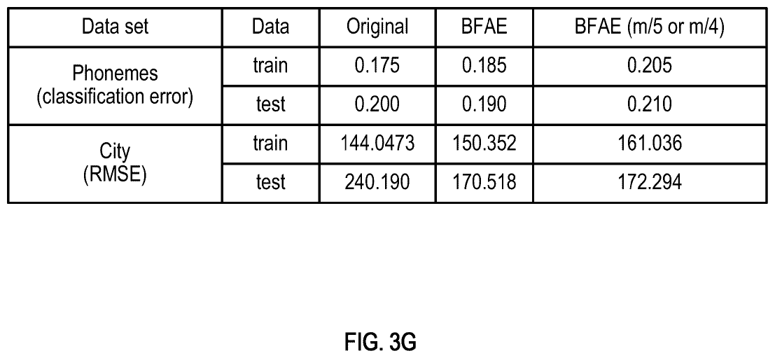

FIGS. 3A and 3B illustrate the flow diagram for the application of the dimension reduction approach, in accordance with an example implementation. With regards to the BFAE model applying module, the flows of FIGS. 3A and 3B are used when applying the learned model for time series data. In the example of FIG. 3A, the flow can be used to retrieve the original input data. The model learned in the functional decoder is used to reconstruct the original time series data from the dimension reduced form.

In the example of FIG. 3B, the flow can be used to apply different analyses according to the desired implementation. The model learned in the functional encoder can be used to obtain the compact form of the data before using it for different analytical tasks and/or to generate new/additional models. The machine learning model is learned for any desired downstream analytics task from the dimension reduced form 111 of the input time series data.

FIGS. 3C to 3E illustrate example implementations as applied to data sets. Specifically, FIG. 3C illustrates phoneme data, in which the feature is observed from FIG. 3C is the voice signal (phoneme curve), wherein each curve (sample) is measured across 150 time points. In the example of FIG. 3C, there are 800 such curves, thereby yielding 800 samples. In the example of FIGS. 3D and 3E, temperature data and electricity demand data are obtained from a city respectively. The feature being observed is the daily temperature curve and the daily electricity demand curve for a city, each of which is measured at 48 time points in a day (at half-hourly rate). One sample can involve seven features (representing each day of the week), for the daily temperature or electricity usage from Monday to Sunday. In the example illustrated in FIGS. 3D and 3E, there are 508 samples, meaning 508 weeks of data.

FIG. 3F illustrates an example comparison of other related art techniques and the proposed BFAE, in accordance with an example implementation. In the example illustrated in FIG. 3F, the phonemes data was broken down into 640 training samples, with 160 test samples over 150 time points to observe a single feature (voice signal). Similarly, the city data was split into 400 training samples and 108 test samples, across 48 time points to observe seven features (energy consumption and temperature for each day of the week). The values displayed are regarding the remapping error (remote mean square loss) between the training and the testing data, which represents how well the model is able to remap the input. Accordingly, a lower value indicates better accuracy.

In example implementations, the BFAE approach can reduce the dimension in two ways. It can reduce the number of features and also reduce the number of timepoints. In the phoneme data, since the number of features is 1, there is no feature reduction. However, for BFAE, there are two cases, one for when the number of timepoints is kept the same, and another for when the number of time points for the phoneme data is reduced from 150 to 30. Similarly, in the city example, there are two cases, one for which the number of time points is same but the features are reduced (48 time points and four features), and a second example in which the time points are reduced by four-fold to 12 time points and the features are reduced from 7 to 4.

As illustrated in FIG. 3F, the proposed BFAE has less remapping error than the related art techniques. In the first example of the BFAE, the time points are maintained without any dimension reduction, so the result is a remapping. In the second example of the BFAE, the timepoints are reduced by five-fold (m=5) for the phonemes sample to 30 time points, and four-fold (m=4) to 12 time points with a feature reduction from seven features to four features. As shown in the resulting table of FIG. 3F, even with time point and/or feature reduction, although there is a slight increase in the remapping error, the proposed BFAE technique performs better than the related art counterparts.

FIG. 3G illustrates example results of a model trained from the proposed BFAE technique, in accordance with an example implementation. Specifically, the functional linear model (FLM) is applied to the real data for classification (Phonemes data) and forecast of electricity (City data). The goal here is to show that the performance in any data analysis task after dimension reduction is as good as using the original data. Thus, even when the data is processed using the proposed BFAE technique, the model generated produces similar results to models trained using the full set of data.

Through the example implementations described herein, by using accurate dimension reduction, it is possible to reduce load and increase the speed of data transfer, reduce data storage needed, increase computation time, and so on without loss of efficiency. The example implementations can achieve this through the proposed dimension reduction algorithm which provides for two-way dimension reduction as well as non-linear dimension reduction for time series.

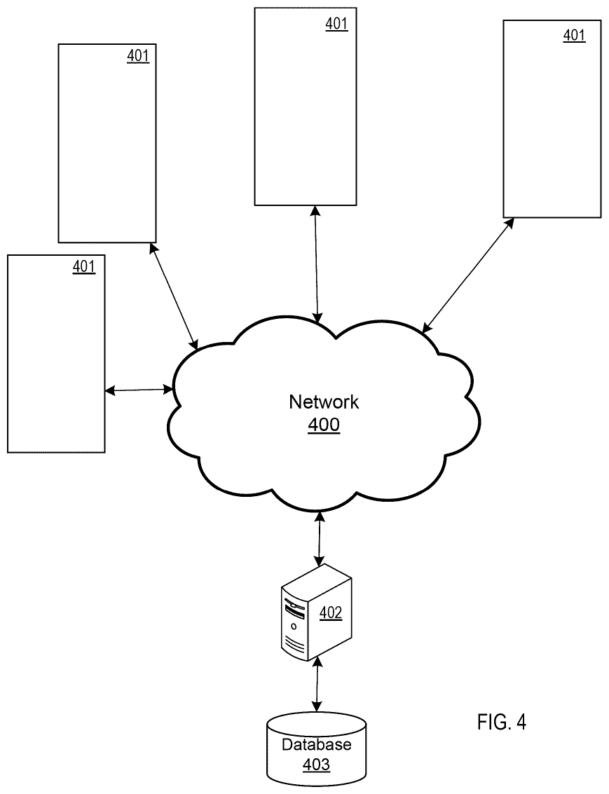

FIG. 4 illustrates a system involving a plurality of physical systems networked to a management apparatus, in accordance with an example implementation. One or more physical systems 401 integrated with various sensors are communicatively coupled to a network 400 (e.g., local area network (LAN), wide area network (WAN)) through the corresponding network interface of the sensor system installed in the physical systems 401, which is connected to a management apparatus 402. The management apparatus 402 manages a database 403, which contains historical data collected from the sensor systems from each of the physical systems 401. In alternate example implementations, the data from the sensor systems of the physical systems 401 can be stored in a central repository or central database such as proprietary databases that intake data from the physical systems 401, or systems such as enterprise resource planning systems, and the management apparatus 402 can access or retrieve the data from the central repository or central database. The sensor systems of the physical systems 401 can include any type of sensors to facilitate the desired implementation, such as but not limited to gyroscopes, accelerometers, global positioning satellite (GPS), thermometers, humidity gauges, or any sensors that can measure one or more of temperature, humidity, gas levels (e.g., CO2 gas), and so on. Examples of physical systems can include, but are not limited to, shipping containers, lathes, air compressors, and any other device that can be networked as an Internet of Things (IOT) device and/or controlled remotely by the management apparatus 402 as needed. Further, the physical systems can also be represented as virtual systems, such as in the form of a digital twin.

In example implementations described herein, the management apparatus 402 may deploy one or more machine learning models such as the functional encoder 110 and functional decoder 112 to generate the dimension reduced form 111. Such dimension reduced form can be used by machine learning models in the management apparatus 402 or transmitted to an external system for analysis. Depending on the analysis from such machine learning models, management apparatus 402 may control the one or more physical systems 401 accordingly. For example, if the analysis indicates that one of the physical systems 401 needs to be shut down or reoriented, management apparatus 402 may control such a physical system to be shut down, reconfigured, or reoriented in accordance with the desired implementation.

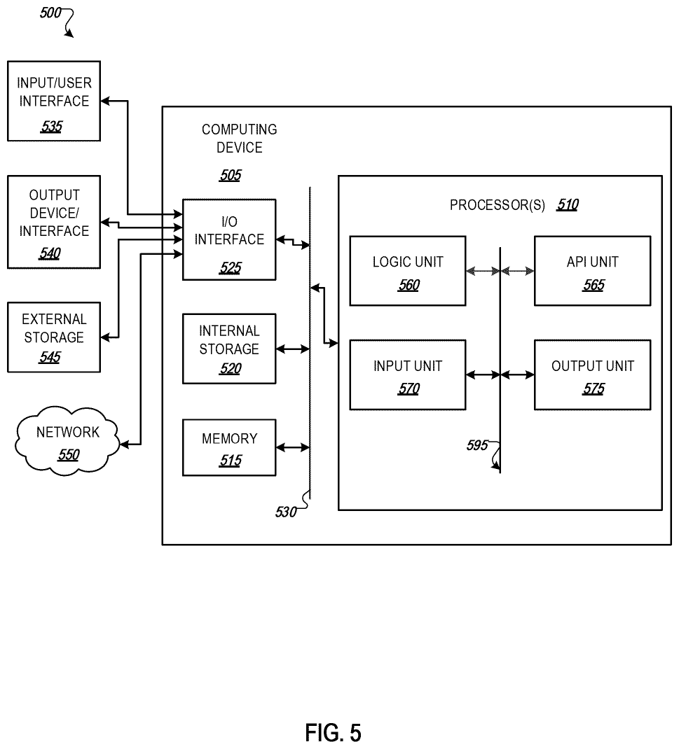

FIG. 5 illustrates an example computing environment with an example computer device suitable for use in some example implementations, such as a management apparatus 402 as illustrated in FIG. 4. Computer device 505 in computing environment 500 can include one or more processing units, cores, or processors 510, memory 515 (e.g., RAM, ROM, and/or the like), internal storage 520 (e.g., magnetic, optical, solid state storage, and/or organic), and/or I/O interface 525, any of which can be coupled on a communication mechanism or bus 530 for communicating information or embedded in the computer device 505. I/O interface 525 is also configured to receive images from cameras or provide images to projectors or displays, depending on the desired implementation.

Computer device 505 can be communicatively coupled to input/user interface 535 and output device/interface 540. Either one or both of input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via I/O interface 525) to external storage 545 and network 550 for communicating with any number of networked components, devices, and systems, including one or more computer devices of the same or different configurations. Computer device 505 or any connected computer device can be functioning as, providing services of, or referred to as a server, client, thin server, general machine, special-purpose machine, or another label.

I/O interface 525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or in a combination of hardware and software units.

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, input unit 570, output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide output based on the calculations described in example implementations.

Processor(s) 510 can be configured to execute a method or instructions involving training a functional encoder 110 involving a plurality of layers of continuous neurons from input time series data to learn a dimension reduced form 111 of the input time series data, the dimension reduced form 111 of the input time series data being at least one of a feature reduced or time point reduced form of the input time series data; and training a functional decoder 112 involving another plurality of layers of continuous neurons to learn the input time series data from the dimension reduced form 111 of the input time series data as illustrated in FIG. 1 and FIG. 2.

Processor(s) 510 can be configured to execute the method or instructions as described herein, and further involve learning a machine learning model for a downstream analytics task from the dimension reduced form 111 of the input time series data as illustrated in FIG. 3B.

Processor(s) 510 can be configured to execute the method or instructions as described herein, which can further involve executing the trained functional decoder 112 to obtain the input time series data from the dimension reduced form of the input time series data as illustrated in FIG. 3A.

Processor(s) 510 can be configured to execute the method or instructions as described herein, which can further involve receiving an input defining at least one of feature reduction or time point reduction for the dimension reduced form of the input time series data; wherein the functional encoder is trained to learn the dimension reduced form of the time series data according to the at least one of the feature reduction or the time point reduction defined by the received input as described with respect to FIGS. 1 and 2.

Processor(s) 510 can be configured to execute the method or instructions as described herein, and further involve receiving another input defining at least one of a number of the plurality of layers of continuous neurons or a number of the continuous neurons; wherein the functional encoder 110 is constructed according to another input as described with respect to FIGS. 1 and 2.

Processor(s) 510 can be configured to execute the method or instructions as described herein, and further involve, for receipt of additional input time series data from a same source of the input time series data, executing the trained functional encoder on the additional input time series data to generate a dimension reduced form of the additional input time series data as described with respect to FIGS. 1 and 2.

Processor(s) 510 can be configured to execute the method or instructions as described herein, wherein the dimension reduced form of the input time series data is a non-linear dimension reduced form.

Processor(s) 510 can be configured to execute the methods or instructions as described herein, wherein each of the continuous neurons is configured to receive a function as an input and executes a non-linear transformation to generate an output function.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying.” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
training a functional encoder comprising a plurality of layers of continuous neurons from input time series data to learn a dimension reduced form of the input time series data, the dimension reduced form of the input time series data being at least one of a feature reduced or time point reduced form of the input time series data; and
training a functional decoder comprising another plurality of layers of continuous neurons to learn the input time series data from the dimension reduced form of the input time series data.

2. The method of claim 1, further comprising learning a machine learning model for a downstream analytics task from the dimension reduced form of the input time series data.

3. The method of claim 1, further comprising executing the trained functional decoder to obtain the input time series data from the dimension reduced form of the input time series data.

4. The method of claim 1, further comprising:
receiving an input defining at least one of feature reduction or time point reduction for the dimension reduced form of the input time series data;
wherein the functional encoder is trained to learn the dimension reduced form of the time series data according to the at least one of the feature reduction or the time point reduction defined by the received input.

5. The method of claim 1, further comprising:
receiving another input defining at least one of a number of the plurality of layers of continuous neurons or a number of the continuous neurons;
wherein the functional encoder is constructed according to the another input.

6. The method of claim 1, further comprising, for receipt of additional input time series data from a same source of the input time series data, executing the trained functional encoder on the additional input time series data to generate a dimension reduced form of the additional input time series data.

7. The method of claim 1, wherein the dimension reduced form of the input time series data is a non-linear dimension reduced form.

8. The method of claim 1, wherein each of the continuous neurons is configured to receive a function as an input and executes a non-linear transformation to generate an output function.

9. A non-transitory computer readable medium, storing instructions for executing a process, the instructions comprising:
training a functional encoder comprising a plurality of layers of continuous neurons from input time series data to learn a dimension reduced form of the input time series data, the dimension reduced form of the input time series data being at least one of a feature reduced or time point reduced form of the input time series data; and
training a functional decoder comprising another plurality of layers of continuous neurons to learn the input time series data from the dimension reduced form of the input time series data.

10. The non-transitory computer readable medium of claim 9, the instructions further comprising learning a machine learning model for a downstream analytics task from the dimension reduced form of the input time series data.

11. The non-transitory computer readable medium of claim 9, the instructions further comprising executing the trained functional decoder to obtain the input time series data from the dimension reduced form of the input time series data.

12. The non-transitory computer readable medium of claim 9, the instructions further comprising:
receiving an input defining at least one of feature reduction or time point reduction for the dimension reduced form of the input time series data;
wherein the functional encoder is trained to learn the dimension reduced form of the time series data according to the at least one of the feature reduction or the time point reduction defined by the received input.

13. The non-transitory computer readable medium of claim 9, the instructions further comprising:
receiving another input defining at least one of a number of the plurality of layers of continuous neurons or a number of the continuous neurons;
wherein the functional encoder is constructed according to the another input.

14. The non-transitory computer readable medium of claim 9, the instructions further comprising, for receipt of additional input time series data from a same source of the input time series data, executing the trained functional encoder on the additional input time series data to generate a dimension reduced form of the additional input time series data.

15. The non-transitory computer readable medium of claim 9, wherein the dimension reduced form of the input time series data is a non-linear dimension reduced form.

16. The non-transitory computer readable medium of claim 9, wherein each of the continuous neurons is configured to receive a function as an input and executes a non-linear transformation to generate an output function.

17. An apparatus, comprising:
a processor, configured to:
train a functional encoder comprising a plurality of layers of continuous neurons from input time series data to learn a dimension reduced form of the input time series data, the dimension reduced form of the input time series data being at least one of a feature reduced or time point reduced form of the input time series data; and
train a functional decoder comprising another plurality of layers of continuous neurons to learn the input time series data from the dimension reduced form of the input time series data.
